(19) United States
(12) Patent Application Publication
(10) Pub. No.: US 2022/0092385 A1
(43) Pub. Date: Mar. 24, 2022

(54) INFORMATION PROCESSING DEVICE AND INFORMATION PROCESSING SYSTEM

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Yusuke NATSUI, Yokosuka Kanagawa (JP)

(21) Appl. No.: 17/203,063

(22) Filed: Mar. 16, 2021

(30) Foreign Application Priority Data
Sep. 18, 2020 (JP) 2020-157670

(51) Int. Cl. G06N 3/04; G06N 3/063

(52) U.S. Cl. CPC G06N 3/04; G06N 3/063

(57) ABSTRACT

An Information processing device includes one or more memories and one or more processing circuitry. The one or more memories are configured to store information that identifies hardware, information that identifies a deep neural network (DNN) structure, and an execution time when the hardware executes the DNN structure. The one or more processing circuitry is configured to search for whether a combination of target hardware and a target DNN structure is stored in the memories, and acquire the execution time from a combination of the target hardware and the target DNN structure based on a search result of the search unit.

### CROSS REFERENCE TO RELATED APPLICATIONS

This application is based upon and claims the benefit of priority from the prior Japanese Patent Application No. 2020-157670, filed on Sep. 18, 2020, the entire contents of which are incorporated herein by reference.

### FIELD

Embodiments of the present invention relate to an information processing device and an information processing system.

### BACKGROUND

When optimizing the structure of a deep neural network (DNN) for specific hardware, a network structure search method is used to determine the structure of the DNN. In network structure search, it is generally necessary to set and evaluate a large number of structures. For example, about new hardware that did not use the DNN until now, when optimizing it for the hardware including execution time, it is necessary to measure and evaluate the execution time on the hardware.

However, evaluation of one structure generally takes an enormous amount of time because program regarding to each neural network structure has to be compiled and executed, respectively, and it is difficult to complete the network structure search in a realistic amount of time. In order to use the DNN effectively, it is required to evaluate this structure at high speed.

### BRIEF DESCRIPTION OF DRAWINGS

FIG. 1 is a block diagram showing a configuration of an information processing device according to an embodiment;

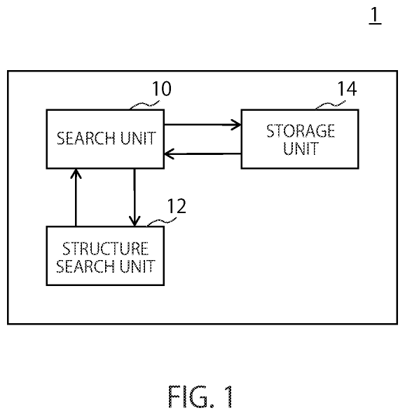

FIG. 2 is a flowchart showing a process of an information processing device according to an embodiment;

FIG. 3 is a block diagram showing a configuration of an information processing device according to an embodiment;

FIG. 4 is a flowchart showing process of an information processing device according to an embodiment;

FIG. 5 is a flowchart showing process of an information processing device according to an embodiment;

FIG. 6 is a block diagram showing a configuration of an information processing device according to an embodiment;

FIG. 7 is a flowchart showing process of an information processing device according to an embodiment;

FIG. 8 is a block diagram showing a configuration of an information processing device according to an embodiment; and

FIG. 9 is a flowchart showing a process of an information processing device according to an embodiment.

### DETAILED DESCRIPTION

According to one embodiment, an Information processing device includes one or more memories and one or more processing circuitry. The one or more memories are configured to store information that identifies hardware, information that identifies a deep neural network (DNN) structure, and an execution time when the hardware executes the DNN structure. The one or more processing circuitry is configured to search for whether a combination of target hardware and a target DNN structure is stored in the memories, and acquire the execution time from a combination of the target hardware and the target

DNN structure based on a search result of the search unit.

Hereinafter, embodiments will be described with reference to the drawings. In the explanation, words such as “greater than” and “less than” may be used. This may be appropriately read as “greater than or equal to” “less than or equal to” and the like.

(First Embodiment)

An information processing device 1 includes a structure search unit 12, a search unit 10, and a storage unit 14. Although not shown in the figure, the information processing device 1 appropriately includes an input/output interface. Search target input, information output, etc. are performed via this input/output interface. While there is the hardware and the DNN structure for which processing time has already been measured, the hardware and the DNN structure for which the processing time is to be estimated are described as the hardware to be a target (target hardware) and the DNN structure to be a target (target DNN structure).

The information processing device 1 evaluates the processing time when a trained DNN having a target structure is used in the target hardware. For example, it evaluates how much processing time it takes when the image acquired by the camera module is input to the DNN that extracts a car, a person, an obstacle, etc. in the image in an in-vehicle device. For this evaluation, for example, in addition to the DNN structure and the hardware, information such as the size of the input data, for example, the resolution of the image may be used.

The above is just an example, and the present invention is not limited to this example. The processing time can be evaluated by associating the hardware with the structure of the DNN. The information processing device 1 can be applied to other applications such as factory line control, plant control, and surveillance cameras.

The structure of DNN (also described below as DNN structure) is determined by, for example, how many layers the DNN has, whether there are branches, or how the combination of respective layers is, how the kernel and step of the convolution layer are, or how the overlap of features is.

A models with a DNN structure is often called a DNN model, for example, as a unit that executes some meaningful task such as outputting a classification result when an image is input. As an example, the structure of DNN in the present disclosure is used for an object for which the processing time when executing the above tasks is measured.

The case where the structure of one DNN containing a plurality of tasks is divided into the structures of a plurality of DNNs having one or a plurality of tasks is considered. In such a case, when focusing on the structure of a divided DNN, a variable input to the input layer of this DNN structure can be considered as a variable output from the output layer of one or a plurality of DNN structures immediately before. Therefore, it is possible to apply the embodiment of the present disclosure to the structures of the plurality of divided DNNs.

For example, when the processing time when a piece of hardware processes the structure of a divided DNN can be observed or estimated, it is also possible to apply the device and method of the embodiment to the structure of this divided DNN, and estimate the processing time by another hardware. As described above, the form described in the present disclosure can be applied to part of the structure of the target DNN structure.

For example, hardware is based on the specifications of various central processing units (CPUs), graphics processing units (GPUs), and other accelerators.

The search unit 10 searches for whether the data for searching the structure is stored in the storage unit 14.

The structure search unit 12 searches, based on the result of the search by the search unit 10, presence or absence of information such as the processing time of the DNN structure which is the target for the hardware which is the target. The structure search unit 12 is a processing unit that performs searches for a structure suitable for a hardware. The structure search unit 12 iteratively executes the generation of the structure and the evaluation of the structure. During the execution of this generation and evaluation of the structure, the structure search unit 12 inputs the generated structure and the target hardware into the search unit 10 and obtains the execution time based on this search results from the search unit 10. Then, the structure search unit 12 evaluates a combination of the hardware and the structure using the execution time searched by the search unit 10. If there is no result of running on the target hardware, the structure search unit 12 performs the execution time evaluation from data about the execution time of hardware similar to the target hardware.

The search unit 10 determines whether it is registered in the storage unit 14 based on the combination of the input structure and hardware. If the search unit 10 find a corresponding structure, the structure search unit 12 acquires the structure, the hardware, and the execution time information from the search unit 10.

The search may be performed using not only a combination of the hardware and structure but also other information as a key.

The storage unit 14 includes, for example, memories such as various random access memories (RAMs). Also, as another example, it is not essential that the storage unit 14 is included in the information processing device 1. It may be a storage or the like outside the information processing device 1. The information in this storage unit 14 is managed by, for example, a database, and is stored in association with hardware information and the processing time when the hardware processes various DNN structures.

This storage unit 14 stores, for example, information for identifying the hardware, information for identifying the DNN structure, and the execution time associated with these two recognition information. In other words, the storage unit 14 stores a hardware identifier, a DNN structure identifier, and the execution time information associated with these. The search unit 10 may search for information on the processing time when a piece of hardware executes a certain DNN structure in association with these identifiers.

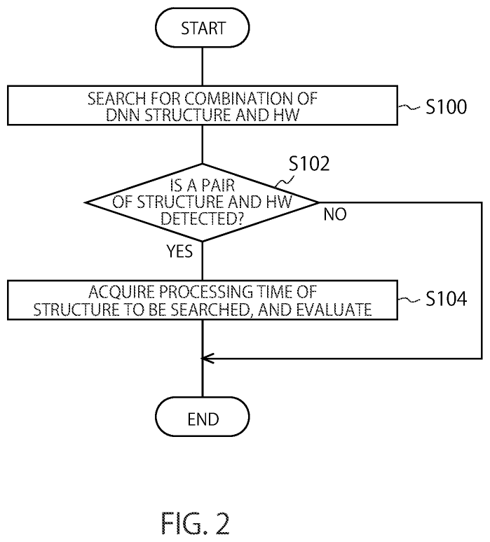

FIG. 2 is a flowchart showing the process of the information processing device according to the present embodiment.

First, the structure search unit 12 iteratively executes the generation of the structure and the evaluation of the structure.

During the generation and the evaluation of the structure, the structure search unit 12 inputs the generated structure and the target hardware into the search unit 10 and the search unit 10 searches for whether a combination of a target DNN structure and hardware (hereinafter referred to as HW) is registered in the storage unit 14 (S100).

Next, the search unit 10 determines whether presence or absence of a combination of the target DNN structure and the HW (S102). When the combination does not exist (S102: NO), the process ends.

When the combination of the target DNN structure and the HW exists (S102: YES), the structure search unit 12 acquires, from the search unit 10, information about the processing time based on the combination of the DNN structure to be searched and the HW, and executes the evaluation of the structure (S104). The structure search unit 12 appropriately outputs this acquisition result and ends the process.

As mentioned above, according to the embodiment, the processing time of the combination of the HW and the DNN structure can be evaluated based on the information stored in the database etc.

(Second Embodiment)

In the aforementioned embodiment, evaluation is performed based on the data existing in the database. In this embodiment, further, evaluation is performed from data that does not exist in the database by considering the similarity between pieces of hardware.

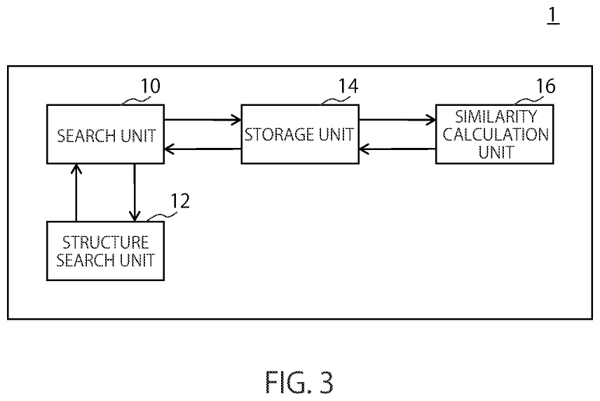

FIG. 3 is a block diagram showing a configuration of the information processing device according to the present embodiment. The information processing device 1 includes, as described above, the search unit 10, the structure search unit 12, and the storage unit 14, and further includes a similarity calculation unit 16.

The similarity calculation unit 16 calculates the similarity between the HW based on the data stored in the storage unit 14 to store it in the storage unit 14. The similarity calculation unit 16 calculates the similarity between the HW when the storage unit 14 stores the execution time of a plurality of pieces of HW on a plurality of DNN structures.

The similarity calculation unit 16 acquires the similarity by, for example, calculating the rank correlation. For example, the value obtained as the rank correlation is used as the similarity.

In calculating this rank correlation, the similarity calculation unit 16 may group, for example, by convolution type, the number, and input size to calculate the rank layer for each group, so that the accuracy of the similarity between the pieces of HW may be improved precisely. Of course, the similarity may be calculated without grouping.

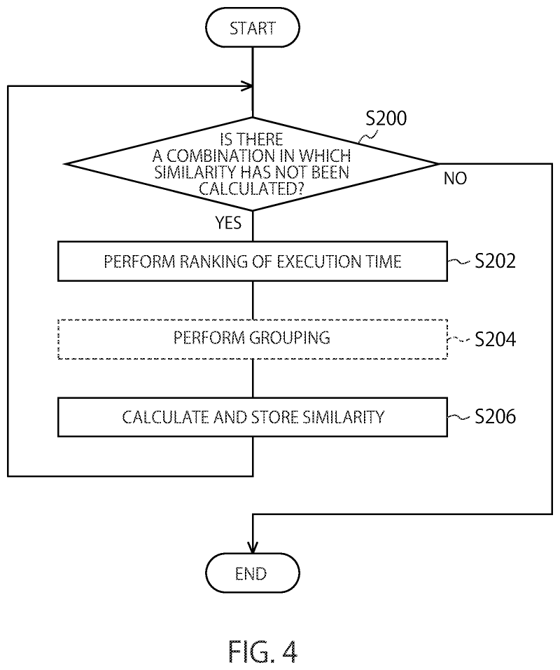

FIG. 4 is a flowchart showing the processing of the similarity calculation unit 16 according to the present embodiment. First, in FIG. 4, generation of the database stored in the storage unit 14 according to the present embodiment will be described. As described above, the storage and data acquisition formats are not limited to the database, but any format may be used as long as the appropriately linked data can be acquired.

First, the similarity calculation unit 16 determines whether there is a combination of uncalculated similarity among the data stored in the storage unit 14 (S200). In this determination, for example, that the new DNN structure and the HW data have been stored in storage unit 14 may be flagged. Further, for example, the similarity calculation unit 16 may hold the latest update date and time as a time-stamp, and may detect that there is data newer than this time-stamp. This detection may be performed at a predetermined time. For example, it may be detected periodically by cron or the like. In addition, it may be confirmed whether the similarity is calculated for all the stored data at a predetermined time.

The similarity calculation unit 16 extracts the combination of the HW in which information about the execution time related to the plurality of pieces of HW for two or more DNN structures is stored, and the similarity has not been calculated.

When there is a combination in which the similarity has not been calculated (S200: YES), the similarity calculation unit 16 performs ranking of the execution time (S202). For example, in two pieces of HW A and B, it is assumed that the execution time on the three DNN structures X, Y, and Z are stored in the storage unit 14. In this case, the execution time is ranked for each of the HW A and B. For example, the execution time of the DNN structures is ranked in such a way that in the HW A, the execution time is x >y>z, and in the HW B, the execution time is x >z>y.

Next, the similarity calculation unit 16 executes grouping (S204). The grouping may be performed by convolution type, the number, or input size. Note that this processing is not essential and may be omitted.

Next, the similarity calculation unit 16 calculates the rank correlation between the two pieces of HW and stores it in the storage unit 14 as the similarity (S206). The rank correlation may be calculated by, for example, any of the following methods, but is not limited to these methods.

The similarity calculation unit 16 may calculate the similarity using the Kendall rank correlation coefficient shown below.

$$τ = \frac{K - L}{( \begin{matrix}n \\ 2\end{matrix} )} = \frac{2 ( K - L )}{n ( n - 1 )} \qquad ( 1 )$$

Where n represents the number of DNN structures in which the execution time is stored in common in two pieces of HW, K represents the number of pairs whose ranks match in each HW in n DNN structures, and L represents the number of pairs whose ranks do not match in each HW in n DNN structures. More specifically, when the processing times of n DNN structures are arranged in order, K represents the number of combinations in which magnitude relationships match and L represents the number of combinations in which magnitude relationships do not match. For example, in the HW A, B, when there is data of the processing times of the DNN structures X, Y, K is incremented by +1 when the processing time is x_{A}>y_{A} and x_{B}>y_{B}, and conversely, L is incremented by +1 when the processing time is x_{A}>y_{A} and y_{B}>X_{B}.

The similarity calculation unit 16 may calculate the similarity using the Spearman's rank correlation coefficient shown below.

$$ρ = 1 - \frac{6 {\sum }_{i = 1}^{n} {d}_{i}^{2}}{n ( {n}^{2} - 1 )} \qquad ( 2 )$$

Where dᵢ represents the difference in rank of the same DNN structure in two pieces of HW.

The similarity calculation unit 16 may calculate the similarity using Goodman and Kruskal's gamma shown below.

$$γ = \frac{K - L}{K + L} \qquad ( 3 )$$

The similarity calculation unit 16 may calculate the similarity using Somers'D below.

$$D = \frac{τ ( A , B )}{τ ( A , A )} \qquad ( 4 )$$

The similarity calculation unit 16 calculates the similarity based on the equations given in Equations (1) to (4) as some examples to store the similarity in the storage unit 14.

The similarity calculation unit 16 stores the similarity in the storage unit 14, and then repeats the process from S200. When there is no combination in which the similarity has not been calculated (S200: NO), the similarity calculation unit 16 ends the processing.

Based on the similarity acquired in this way, the information processing device 1 evaluates the execution time of the DNN structure which is the target for the HW which is the target.

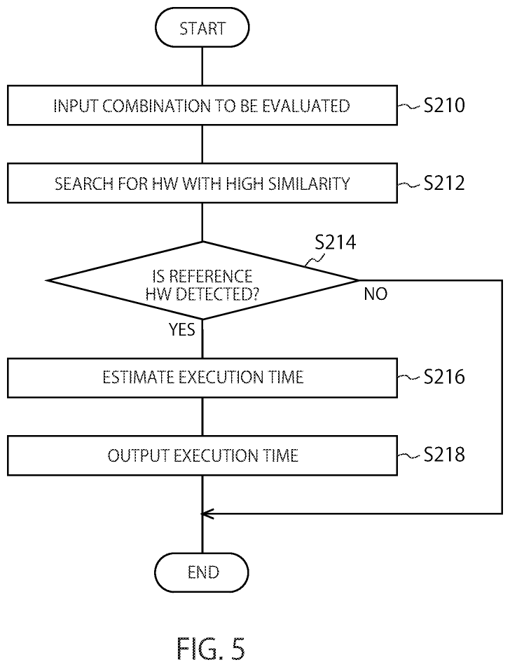

FIG. 5 is a flowchart showing the processing of evaluating the execution time of the information processing device according to the present embodiment.

First, via an interface (not shown), the information processing device 1 receives an input of the DNN structure (hereinafter, target structure) to be evaluated in the HW to be evaluated (hereinafter, target HW) (S210).

Next, the search unit 10 searches for HW (hereinafter referred to as reference HW) having a high degree of similarity to the target HW among the pieces of HW having the execution time data of the target structure (S212). For example, the search unit 10 may extract HW having a similarity higher than a predetermined threshold value as the reference HW. As another example, the search unit 10 may extract HW having the highest similarity to the target HW as the reference HW.

Next, the search unit 10 determines whether the reference HW can be detected (S214). The determination is made based on whether the reference HW can be extracted in the above process of S212. For example, when the search unit 10 cannot extract HW having a similarity exceeding a predetermined threshold, or cannot detect HW in which the similarity is calculated between the target HW (S214: NO), the information processing device 1 ends the process.

When the reference HW can be detected by the search unit 10 (S214: YES), the structure search unit 12 estimates the execution time of the target HW in the target structure to use for the evaluation (S216). The execution time is estimated based on the execution time of the target structure and the DNN structure stored in common with the target HW by the reference HW, and the execution time of the DNN structure stored in common with the reference HW by the target HW.

As an example, A represents the reference HW and B represents the target HW, and in HW A, B, X and Y represent the DNN structure in which the execution time is commonly stored in the storage unit 14, and Z represents the target structure. Also, the execution times of the DNN structures X, Y, and Z by each HW are represented by xa, ya, za, xb, yb, and zb. The execution time to be estimated is zb.

Assume that the execution times by the HW A are xa<ya<za. The similarity between the HW A and the HW B is high.

Here, the structure search unit 12 estimates that the execution time of the HW B is xb<yb<zb. Then, using xa, ya, za, xb, and yb, zb is calculated by extrapolation.

$${z}_{b} = {y}_{b} + ( {z}_{a} - {y}_{a} ) \times \frac{{y}_{b} - {x}_{b}}{{y}_{a} - {x}_{a}} \qquad ( 5 )$$

When the target structure is Y, it is calculated by interpolation.

$${y}_{b} = {x}_{b} + ( {y}_{a} - {x}_{a} ) \times \frac{{z}_{b} - {x}_{b}}{{z}_{a} - {x}_{a}} \qquad ( 6 )$$

The above is described as an example, and is not limited to these equations. For example, Equation (5) may be zb=xb+ . . . with reference to xb, and Equation (6) may be yb=zb− . . . with reference to zb. Further, when it is possible to use large amount of data, regression analysis such as the least squares method, multiple regression analysis, analysis of covariance, or the like may be performed. In this way, the structure search unit 12 estimates the execution time of the target structure by the target HW structure by linear approximation, curve approximation, or the like.

Also, as another example, a neural network model for estimating the execution time of the target structure may be formed in advance by training based on the DNN structure where the execution times are registered in the reference HW and the target HW. Then, the execution time of the target structure by the target HW may be estimated using this neural network model.

When it is not linear interpolation, interpolation may be performed using the referenced DNN structure based on more DNN structures instead of three (X, Y, Z).

Next, the structure search unit 12 outputs the estimated execution time (S218), and ends the process.

As mentioned above, according to the embodiment, the execution time for each structure and HW is recorded, the similarity between HW is calculated from the execution times of a plurality of structures by a plurality of pieces of HW, and it is possible to estimate the execution time when executed by the target HW based on this similarity. As a result, based on the execution time when a piece of HW executes a certain structure which is already stored in the database etc., even when the HW which is a target does not actually process the structure on which it is desired to obtain the execution time, the execution time can be estimated without the target HW performing the process.

(Third Embodiment)

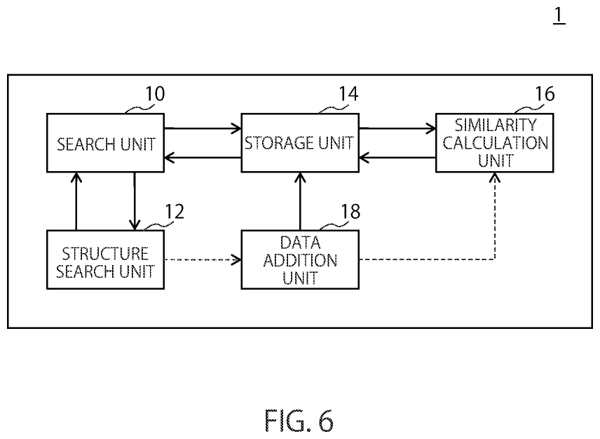

In the aforementioned embodiment, while the similarity is calculated to estimate the execution time related to the target structure of the target HW that does not exist in the database, it does not add the structure itself. Therefore, in the present embodiment, the information processing device 1 that executes the addition of the structure not registered in the database will be described. FIG. 6 is a block diagram showing a configuration of the information processing device 1 according to the present embodiment. The information processing device 1 further includes a data addition unit 18 in addition to the configuration of the information processing device 1 of the second embodiment.

The data addition unit 18 stores the information of the execution time on the DNN structure and the input size executed by a certain piece of HW in the storage unit 14. Using the added data, the similarity calculation unit 16 adds the similarity data or updates the similarity data.

The data addition unit 18 may notify the similarity calculation unit 16 that the data has been added, as shown by the broken line. Upon receiving this notification, the similarity calculation unit 16 may execute the calculation of the similarity. As another example, as described in the above embodiments, the similarity calculation unit 16 may check the data in the storage unit 14 at predetermined time intervals, or may monitor the addition of data.

Further, as shown by the broken line, the data addition unit 18 may store data in the storage unit 14 with respect to the structure as a result of the search by the structure search unit 12.

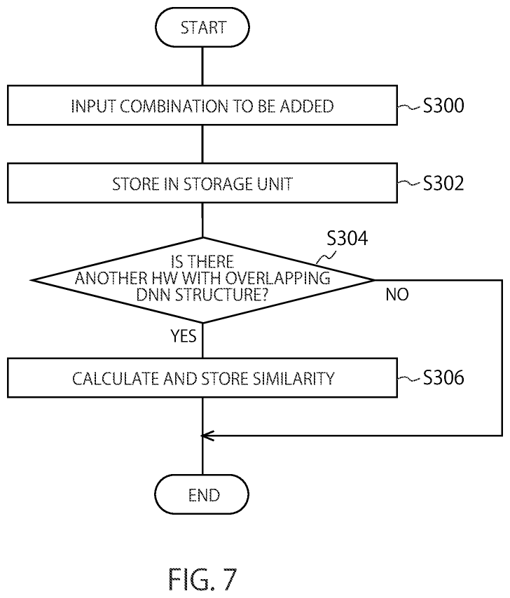

FIG. 7 is a flowchart showing the process of the information processing device 1 according to the present embodiment.

First, the information processing device 1 accepts the input of the data of the HW and DNN structure for which the execution time is to be registered and the execution time (S300).

Next, the data addition unit 18 stores the accepted data in the storage unit 14 (S302). The stored DNN structure is hereinafter referred to as a storage structure.

Next, the search unit 10 detects whether the execution time of the storage structure is stored in the plurality of pieces of HW (S304). When the execution time of the storage structure is not stored in the plurality of pieces of HW (S304: NO), the information processing device 1 ends the process.

When the execution time of the storage structure is stored in the plurality of pieces of HW (S304: YES), the similarity calculation unit 16 calculates and store the similarity between the pieces of HW in which the execution time of this storage structure is stored (S306). This calculation is performed, for example, by obtaining a rank correlation, as in the above-described embodiment.

As described above, according to the present embodiment, when the structure is added, the similarity between the pieces of HW can be kept up to date.

The data addition unit 18 may add data via the similarity calculation unit 16. In this case, the data addition unit 18 transmits the data to be added to the similarity calculation unit 16, the similarity calculation unit 16 that received this data calculates the similarity, and data such as the DNN structure to be added together with this similarity data may be stored in the storage unit 14.

(Fourth Embodiment)

In the third embodiment described above, the registration of a new DNN structure is described. In the embodiment, the information processing device 1 and an information processing system 2 that causes the HW to perform the process based on the DNN structure to acquire the execution time and add the data.

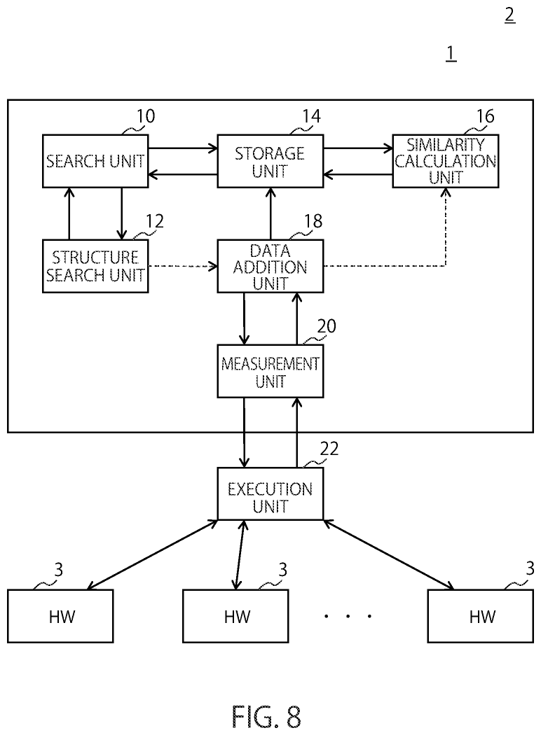

FIG. 8 is a block diagram showing a schematic configuration of the information processing system 2 and the information processing device 1 according to the present embodiment. The information processing device 1 further includes a measurement unit 20 in addition to the configuration of the above-described embodiment. The information processing system 2 includes the information processing device 1 and an execution unit 22. Note that this configuration is an example, and the execution unit 22 may be provided in the information processing device 1. Further, the plurality of pieces of HW may be provided in the information processing system 2.

The execution unit 22 causes the plurality of pieces of HW to execute a model of the target DNN structure. The plurality of pieces of HW 3 may not execute the model, but one HW may execute the model. As described above, the execution unit 22 may be provided in the information processing device 1. Further, the plurality of pieces of HW 3 may also be provided in the information processing device 1, or an emulator capable of emulating the execution time or a simulator capable of simulating the execution time may be provided in the information processing device 1.

A measurement unit 20 measures the execution time by various pieces of HW executed by the execution unit 22.

The execution unit 22 receives information on the DNN structure and the input size, and causes each HW to execute this structure. As described above, this execution is executed on the actual machine or the emulator or simulator. With this configuration, the execution time on the

DNN structure and the input size can be stored in the storage unit 14 as new data.

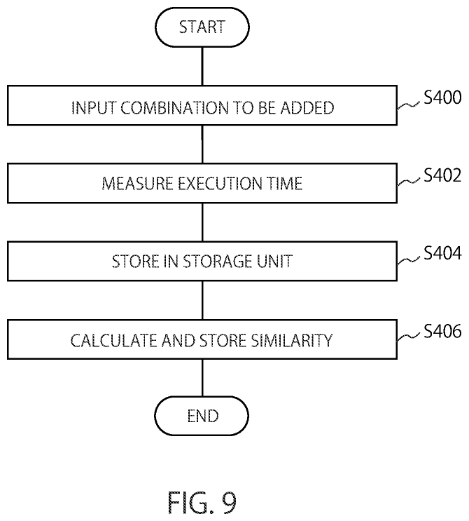

FIG. 9 is a flowchart showing the process of the present embodiment.

First, the information processing device 1, as a storage structure, accepts the DNN structure and the input size to be added, and the input of the execution time by a certain piece of HW (S400).

Next, the execution unit 22 causes one or a plurality of pieces of HW to execute the process based on the storage structure, and the measurement unit 20 measures this execution time (S402). This execution may be performed in various ways. For example, the execution unit 22 may cause one or a plurality of pieces of HW to execute processes based on a plurality of input sizes of a DNN structure to obtain the time. Further, for the data already stored in the storage unit 14, the execution may be omitted, or the data may be executed again to update the data.

In S400, the input is accepted, but the present invention is not limited to this. For example, for a DNN structure for which the execution time by a certain piece of HW is stored, but no execution time by another piece of HW is stored, the execution unit 22 causes the storage unit 14 to acquire the execution time of this DNN structure by the another HW. In this way, the execution unit 22 may access the storage unit 14 and operate to interpolate the data. For this execution, the resource can be effectively used, for example, by using the idle time of the information processing device 1.

Next, the measurement unit 20 stores the combination of the execution time, the HW and the DNN structure in the storage unit 14 (S404).

Next, the similarity calculation unit 16 uses the newly stored execution time to calculate the similarity between the pieces of HW, and when not registered, registers it, or when already registered, update the registered similarity (S404).

As described above, according to the present embodiment, it is possible to measure and store the execution time when various pieces of HW execute various DNN structures. Furthermore, by calculating the similarity, it is possible to improve the estimation accuracy of the execution time between the pieces of HW for which the similarity is calculated.

Part or all of the above configuration may be formed by a dedicated analog circuit or digital circuit such as an application specific integrated circuit (ASIC). Further, it may be formed by a programmable circuit such as a field programmable gate array (FPGA). Further, a general-purpose processing circuitry such as a central processing unit (CPU) may execute information processing by software. When information processing by software is specifically realized using HW resources, programs, executable files, etc. required for processing the software may be stored in, for example, the storage unit 14. One or a plurality of this processing circuitry may be provided, and the storage unit 14 may include one or a plurality of memories.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing device comprising:
one or more memories configured to store information that identifies hardware, information that identifies a deep neural network (DNN) structure, and an execution time when the hardware executes the DNN structure; and
one or more processing circuitry configured to:
search for whether a combination of target hardware and a target DNN structure is stored in the memories; and
acquire the execution time from a combination of the target hardware and the target DNN structure based on a search result of the search unit.

2. The information processing device according to claim 1, wherein
the processing circuitry calculates a similarity between the pieces of hardware based on a combination of the DNN structure and the execution time.

3. The information processing device according to claim 2, wherein
the processing circuitry calculates a rank correlation using the DNN structure and the execution time between a plurality of pieces of the hardware, and acquires the rank correlation as the similarity.

4. The information processing device according to claim 2, wherein
with respect to an execution time of the target DNN structure by reference hardware extracted based on the similarity and an execution time of the DNN structure, by the reference hardware, having a structure same as a structure in the target hardware, the processing circuitry acquires the execution time by performing an interpolation calculation.

5. The information processing device according to claim 2, wherein
with respect to an execution time of the target DNN structure by reference hardware extracted based on the similarity and an execution time of the DNN structure, by the reference hardware, having a structure same as a structure in the target hardware, the processing circuitry acquires the execution time by performing an extrapolation calculation.

6. The information processing device according to claim 2, wherein
the processing circuitry further stores data related to the DNN structure for which the execution time by the hardware is not stored in the memories in the memories, in association with the hardware and the execution time, and
calculates the similarity based on added data.

7. The information processing device according to claim 1, wherein the processing circuitry further causes the hardware to process the DNN structure and measures an execution time.

8. The information processing device according to claim 1, wherein
the processing circuitry further acquires an execution time when the hardware processed the DNN structure.

9. An information processing system comprising:
a search unit configured to search for, from information of information that identifies hardware stored in a storage unit, information that identifies a DNN structure, and an execution time when the hardware executes the DNN structure, whether a combination of target hardware and a target DNN structure is stored in the storage unit; and
a structure search unit configured to acquire the execution time from a combination of the target hardware and the target DNN structure based on a search result of the search unit.

10. The information processing system according to claim 9, further comprising:
a similarity calculation unit configured to calculate a similarity between the pieces of hardware based on a combination of the DNN structure and the execution time;
a data addition unit configured to store data related to the DNN structure for which the execution time by the hardware is not stored in the storage unit, in the storage unit in association with the hardware and the execution time;
a plurality of types of hardware configured to process the DNN structure;
an execution unit configured to cause the plurality of types of hardware to process the DNN structure; and
a measurement unit configured to measure an execution time when the execution unit causes the plurality of types of hardware to process the DNN structure.
